(19) United States
(12) Patent Application Publication
(10) Pub. No.: US 2026/0001722 A1
(43) Pub. Date: Jan. 1, 2026

(54) CONVEYING DEVICE

(71) Applicant: TORAY ENGINEERING CO., LTD., Tokyo (JP)

(72) Inventors: Katsuhiko UEDA, Otsu-shi (JP); Atsuhi WATANABE, Otsu-shi (JP); Kazunori MAEDA, Otsu-shi (JP)

(21) Appl. No.: 19/311,306

(22) Filed: Aug. 27, 2025

Related U.S. Application Data
(63) Continuation of application No. PCT/JP2023/043122, filed on Dec. 1, 2023.

(30) Foreign Application Priority Data
Feb. 28, 2023 (JP) 2023-029446

(51) Int. Cl. B65G 15/58; B65G 43/08; B65G 47/24

(52) U.S. Cl. CPC B65G 15/58; B65G 43/08; B65G 47/24; B65G 2203/0233; B65G 2203/0291

(57) ABSTRACT

A conveying device comprises a conveying section and at least a pair of conveyor units. The conveying section is configured to convey a strip-shaped substrate in a transport direction. The conveyor units are configured to assist transport of the substrate by the conveying section. The conveyor units each include a belt member with a suction portion to which a prescribed surface of the substrate in a vicinity of corresponding one of widthwise ends of the substrate is configured to be attracted by suction force, the belt member being configured to apply a directional force to the substrate in accordance with a traveling direction of the suction portion, and a traveling direction adjustment unit that is configured to adjust the traveling direction of the suction portion.

### CROSS-REFERENCE TO RELATED APPLICATIONS

This application is a continuation application of PCT International Application No. PCT/JP2023/043122 filed on December 1, 2023, which claims priority to Japanese Patent Application No. 2023-029446 filed on February 28, 2023 with Japan Patent Office. The entire disclosures of PCT International Application No. PCT/JP2023/043122 and Japanese Patent Application No. 2023-029446 are hereby incorporated herein by reference.

### BACKGROUND

### Field of the Invention

The present invention relates to a conveying device for conveying a strip-shaped substrate.

### Background Information

In lithium ion batteries, a slurry of electrode material is applied to a strip-shaped substrate such as aluminum foil or copper foil that is conveyed in a roll-to-roll process to form a coating film, and the coating film that has been formed is dried to form a positive or negative electrode. In addition, in order to increase the capacity of lithium ion batteries, it is necessary to form a coating film having uniform thickness on both sides of the substrate.

Japanese Laid-Open Patent Application Publication No. 2012-040467 (Patent Document 1) discloses a double-sided coating device in which a slurry is applied to both sides of a substrate that is conveyed by a conveying device comprising a plurality of rollers that convey the substrate while applying a prescribed tensile force and a suction conveyor that attracts and holds the substrate to assist the transport of the substrate, to thereby form a coating film.

In this double-sided coating device, a first coating unit that applies slurry to the front surface of a substrate is disposed so as to face a substrate that is wound around a backup roller at a prescribed wrap angle, the backup roller being one of the plurality of rollers provided in a conveying device, to apply slurry to the front surface of the substrate while a constant distance is maintained between the first coating unit and the substrate. As a result, a coating film having a constant thickness is formed on the front surface of the substrate. In addition, in the double-sided coating device, a second coating unit that applies slurry to the back surface of the substrate is disposed so as to face a substrate that is attracted and held from the front surface side of the substrate by a suction conveyor to apply slurry to the back surface of the substrate while a constant distance is maintained between the second coating unit and the substrate. As a result, a coating film having a constant thickness is formed on the back surface of the substrate.

### SUMMARY

However, in the above-mentioned conveying device, it has been discovered that the substrate cannot be conveyed in a stable state. That is, in the above-mentioned conveying device, the suction conveyor is disposed and fixed in advance at a position where it is possible to attract and hold a portion of the substrate where a coating film has not been formed, in order to prevent defects in coating film that occur due to the suction conveyor coming in contact with wet coating film that is formed on the substrate. Therefore, even if, on the upstream side of the suction conveyor in the substrate transport path, a misalignment occurs at widthwise ends of the substrate due to vibration of the substrate or sagging of the substrate caused by the weight of the coating film that has been formed, it is difficult for the suction conveyor to adjust the positions of the widthwise ends of the substrate back to the correct positions.

One object of the present disclosure is to provide a conveying device that can adjust the positions of widthwise ends of a substrate.

A conveying device of the present disclosure comprises a conveying section and at least a pair of conveyor units. The conveying section is configured to convey a strip-shaped substrate in a transport direction. The conveyor units are configured to assist the transport of the substrate by the conveying section. The conveyor units each includes a belt member with a suction portion to which a prescribed surface of the substrate in a vicinity of corresponding one of widthwise ends of the substrate is configured to be attracted by suction force, the belt member being configured to apply a directional force to the substrate in accordance with a traveling direction of the suction portion, and a traveling direction adjustment unit that is configured to adjust the traveling direction of the suction portion.

According to the conveying device described above, the traveling direction adjustment unit can adjust the traveling direction of the suction portion to which the prescribed surface of the substrate in the vicinity of corresponding one of the widthwise ends of the substrate is configured to be attracted. Therefore, it is possible to pull the widthwise ends of the substrate toward the adjusted traveling direction of the suction portion. It is thereby possible to adjust the positions of the widthwise ends of the substrate being conveyed.

The conveying device may further comprise an end position detection unit configured to detect positions of the widthwise ends of the substrate, the traveling direction adjustment unit being configured to adjust the traveling direction of the suction portion on the basis of detection result from the end position detection unit.

According to this configuration, the traveling direction adjustment unit can adjust the traveling direction of the suction portion on the basis of the detection result from the end position detection unit. Thus, it is possible to more accurately adjust the positions of the widthwise ends of the substrate.

In addition, the traveling direction adjustment unit may be configured to adjust the traveling direction of the suction portion to be directed further outward in a width direction of the substrate with respect to the transport direction.

According to this configuration, the conveyor units can pull the substrate outward at each of the widthwise ends of the substrate, thereby reducing sagging of the substrate.

In addition, the conveyor units may each further include a speed adjustment unit that is configured to adjust relative speed of the suction portion relative to the substrate in accordance with an adjustment of the traveling direction of the suction portion by the traveling direction adjustment unit.

According to this configuration, the speed adjustment unit can adjust the traveling speed of the suction portion relative to the substrate so that the substrate being conveyed does not become clogged on the suction portion. Therefore, the positions of the widthwise ends of the substrate can be adjusted without impeding the transport of the substrate by the conveying section.

The conveying device may further comprise a first moving mechanism that is configured to move the conveyor units back and forth along the transport direction.

According to this configuration, the first moving mechanism can move the conveyor units back and forth along the transport direction. Thus, it is possible to set, over a wide range, a direction in which each conveyor unit pulls corresponding one of the widthwise ends of the substrate.

In addition, the conveying device may further comprise a second moving mechanism that is configured to move the conveyor units toward or away from the prescribed surface of the substrate.

According to this configuration, it is also possible to adjust the position of the substrate in a direction perpendicular to the prescribed surface of the substrate.

The conveying device may further comprise a sag amount detection unit that is configured to detect a height position of a widthwise central portion of the substrate, the traveling direction adjustment unit being configured to adjust the traveling direction of the suction portion on the basis of detection result from the sag amount detection unit.

According to this configuration, the traveling direction adjustment unit can adjust the traveling direction of the suction portion on the basis of the detection result from the sag amount detection unit. Thus, it becomes easier to reduce sagging of the substrate.

According to the conveying device of the present disclosure, it is possible to adjust the positions of the widthwise ends of the substrate.

### BRIEF DESCRIPTION OF THE DRAWINGS

FIG. 1 is a schematic diagram showing a double-sided coating system comprising a conveying device according to one embodiment of the present disclosure.

FIGS. 2A and 2B are diagrams showing a conveyor unit provided in the conveying device according to one embodiment of the present disclosure, where FIG. 2A is a side view of a conveyor unit 3, and FIG. 2B is a diagram explaining an operation of a traveling direction adjustment unit.

FIG. 3 is a diagram of a pair of conveyor units provided in the conveying device according to one embodiment of the present disclosure as viewed from the front surface side of a substrate.

FIGS. 4A and 4B are diagrams explaining the state of a substrate according to one embodiment of the present disclosure, where FIGS. 4A and 4B are diagrams showing a state in which the positions of both widthwise ends of the substrate have shifted.

FIG. 5 is a diagram explaining a first moving mechanism provided in the conveying device according to one embodiment of the present disclosure.

FIG. 6 is a diagram explaining a second moving mechanism provided in the conveying device according to one embodiment of the present disclosure.

FIGS. 7A and 7B are diagrams showing one variation of a conveyor unit provided in the conveying device according to one embodiment of the present disclosure.

FIG. 8 is a diagram showing a variation in the arrangement of conveyor units provided in the conveying device according to one embodiment of the present disclosure.

FIG. 9 is a diagram showing one variation of conveyor units according to one embodiment of the present disclosure.

### DETAILED DESCRIPTION OF EMBODIMENTS

An embodiment of a conveying device 100 of the present disclosure will be described with reference to the drawings. In the following description, the three axes of a Cartesian coordinate system are X, Y, and Z, wherein the horizontal directions are referred to as the X-axis direction and the Y-axis direction, and the direction perpendicular to the XY plane (i.e., the vertical direction) is referred to as the Z-axis direction.

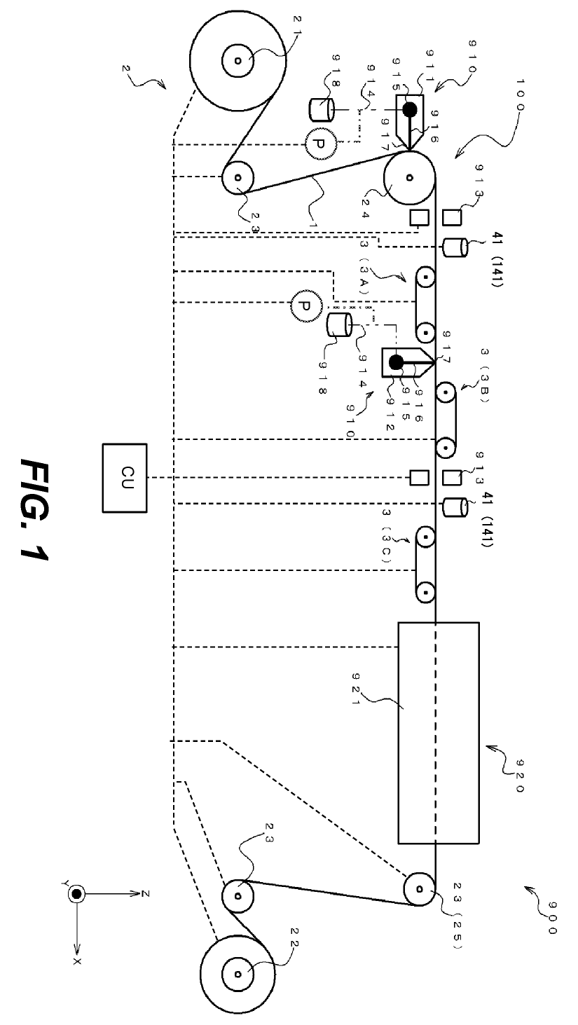

FIG. 1 is a schematic diagram showing a double-sided coating system 900 equipped with the conveying device 100 according to one embodiment of the present disclosure. In the following description, an example will be described in which the conveying device 100 is provided in the double-sided coating system 900 for forming electrodes of a lithium ion battery, but the present invention is not limited to the double-sided coating system 900 and can be applied to any system that conveys a strip-shaped substrate.

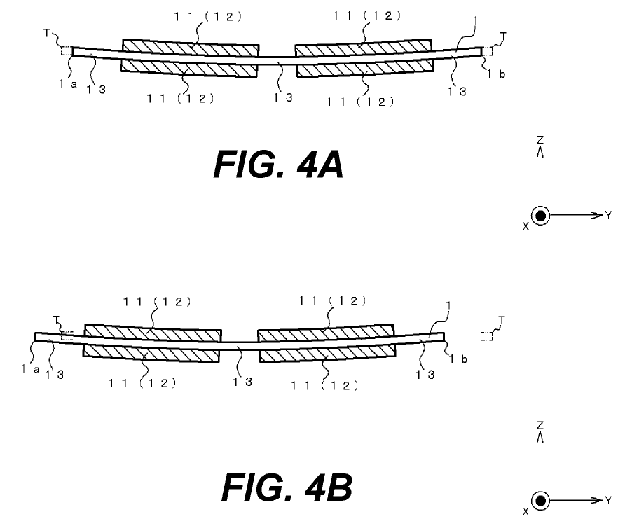

As shown in FIG. 1, the double-sided coating system 900 comprises the conveying device 100 that continuously conveys a substrate 1, a pair of coating mechanisms 910 that applies a coating liquid on both sides of the substrate 1 to form coating films 11, and a drying mechanism or dryer 920 (e.g., a heating unit or heater) that heats and dries the coating films 11 formed on the substrate 1. A slurry (hereinafter referred to as coating liquid) of an electrode material is applied by the coating mechanisms 910 on both sides of the strip-shaped substrate 1 that is conveyed by the conveying device 100 to form the coating films 11 (refer to FIG. 4A), and the coating films 11 that have been formed are dried by the drying mechanism 920 to form a positive or negative electrode of a lithium ion battery.

The substrate 1 is a metal foil that becomes a battery electrode plate of a lithium ion battery; an aluminum foil, etc., is used when forming a positive electrode and a copper foil, etc., is used when forming a negative electrode. The substrate 1 is a strip-shaped substrate that is long in one direction (i.e., a longitudinal direction) and is conveyed by the conveying device 100 so as to pass through each of the sections forming the double-sided coating system 900.

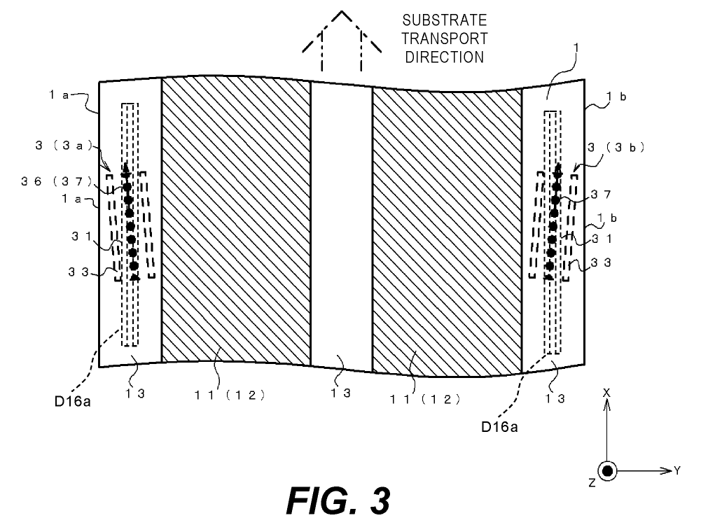

The coating liquid is, for example, a slurry obtained by mixing an active material, a binder, and a conductive assistant in a solvent, and is used as a material (so-called electrode material) for battery electrode plates of lithium ion batteries. This coating liquid is applied to the substrate 1 by the coating mechanisms 910, thereby forming the coating films 11. In the present embodiment, the coating films 11 are formed in a striped pattern. Forming the coating films 11 in a striped pattern means to form the coating films 11 in the width direction of the substrate 1 such that the substrate 1 has a plurality of coated portions 12 where the coating films 11 are formed, and a plurality of uncoated portions 13 where the coating films 11 are not formed between the plurality of coated portions 12, as shown in FIGS. 3 and 4A.

The conveying device 100 is a device for conveying the substrate 1. As shown in FIG. 1, this conveying device 100 comprises a conveying section or main conveyor 2 that conveys the substrate 1, and a plurality of conveyor units or sub conveyors 3 that assist the transport of the substrate 1 by the conveying section 2.

The conveying section 2 is a device for continuously conveying the substrate 1 in the longitudinal direction of the substrate 1. As shown in FIG. 1, the conveying section 2 comprises an unwinding roller 21, a winding roller 22, a plurality of conveying rollers 23, and a coating roller 24. Each of the rollers provided in this conveying section 2 is formed in a cylindrical shape and rotates around the central axis of the cylinder.

The unwinding roller 21 includes a roller for unwinding the substrate 1 to the

The unwinding roller 21 includes a roller for unwinding the substrate 1 to the downstream side, the rotation of which is driven and controlled by a control unit or electrical controller CU to unwind the substrate 1 at a prescribed speed. In the illustrated embodiment, the unwinding roller 21 is operatively coupled to an electronic actuator that is operatively connected to the control unit CU and is driven by the control unit CU to generate rotational force applied to the unwinding roller 21. Of course, a gear mechanism can be provided between the actuator and the unwinding roller 21, as needed and desired. The control unit CU is configured by a general- purpose computer device, for example, and will be treated as such in the following description. For example, the control unit CU includes at least one processor having a CPU (Central Processing Unit) and a storage device or computer memory, and an interface for each device is included as necessary. The control unit CU is operatively coupled to various components of the double-sided coating system 900 to drive and control them. In the illustrated embodiment, only one control unit CU is illustrated that controls various components of the double-sided coating system 900, but the number thereof is not limited to this. A plurality of control units can be provided for driving and controlling various components of the double-sided coating system 900, respectively. In addition, the winding roller 22 includes a roller for winding up the substrate 1, the rotation of which is driven and controlled by the control unit CU, in the same manner as the unwinding roller 21, to wind up the substrate 1 while applying a prescribed tensile force to the substrate 1. Tensile force as used herein refers to the tensile force in a direction (e.g., a transport direction) in which the substrate 1 is conveyed. In the illustrated embodiment, the winding roller 22 is operatively coupled to an electronic actuator that is operatively connected to the control unit CU and is driven by the control unit CU to generate rotational force applied to the winding roller 22. Of course, a gear mechanism can be provided between the actuator and the winding roller 22, as needed and desired.

The conveying rollers 23 are provided such that the substrate 1 that is unwound from the unwinding roller 21 passes therethrough until being wound up by the winding roller 22. As shown in FIG. 1, a plurality of the conveying rollers 23 are provided, which are arranged such that the substrate 1 passes through each of the sections forming the double-sided coating system 900. The rotations of one, some or all of the plurality of conveying rollers 23 are driven and controlled by the control unit CU, in the same manner as the unwinding roller 21 and the winding roller 22, to convey the substrate 1 while applying a prescribed tensile force to the substrate 1. In the illustrated embodiment, at least one of the conveying rollers 23 is each operatively coupled to an electronic actuator that is operatively connected to the control unit CU and is driven by the control unit CU to generate rotational force applied to the at least one of the conveying rollers 23. Of course, a gear mechanism can be provided between the actuator and the conveying roller 23, as needed and desired.

The coating roller 24 includes a roller for guiding the substrate 1 to a position at which a first coating unit 911 applies a coating liquid. As shown in FIG. 1, this coating roller 24 is arranged so as to face the first coating unit 911 and supports the substrate 1 from the back surface side of the substrate 1 at a prescribed wrap angle. As a result, it is possible to convey the substrate 1 while maintaining a constant distance from the first coating unit 911.

With these configurations, the conveying section 2 conveys the substrate 1 at a prescribed speed while applying a prescribed tensile force to the substrate 1.

In addition, as shown in FIG. 1, the drying mechanism 920 and a second coating unit 912 that forms the coating films 11 on the back surface of the substrate 1 are arranged along the transport path of the substrate 1 formed of the coating roller 24 and the conveying roller 23 through which the substrate 1 passes next (hereinafter referred to as conveying roller 25). That is, formation of the coating films 11 on both sides of the substrate 1 and drying of the coating films 11 are carried out before the substrate 1 that is unwound from the unwinding roller 21 reaches the conveying roller 25. It is thereby possible to prevent each of the rollers of the conveying section 2 from coming in contact with the coating films 11 that are in a wet state. The conveyor units 3 assist the transport of the substrate 1 during the period in which the substrate 1 that is unwound from the unwinding roller 21 passes through the coating roller 24 and reaches the conveying roller 25.

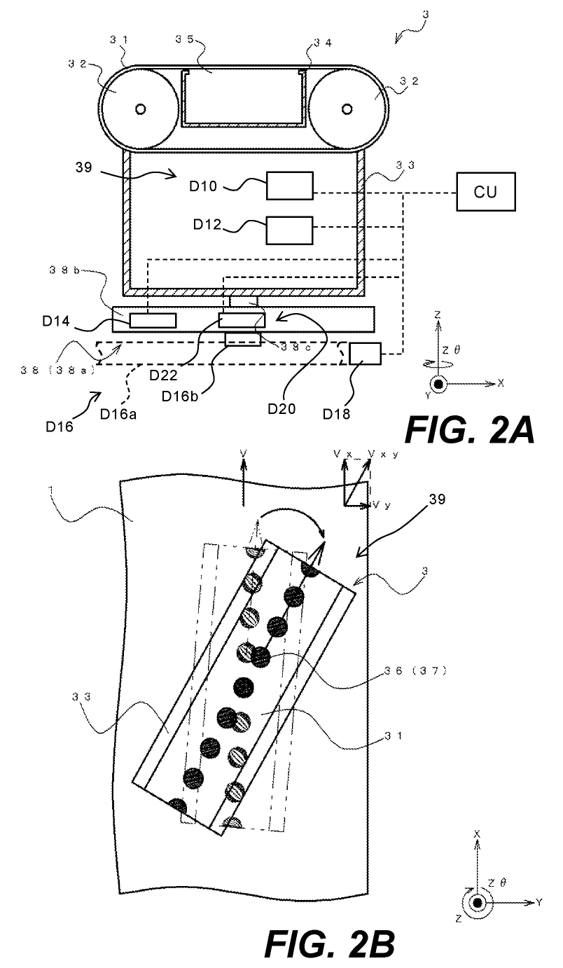

The conveyor units 3 are provided for assisting the conveying section 2 in conveying the substrate 1. As shown in FIG. 2A, the conveyor units 3 each have an endless or looped belt member or belt 31, two rollers 32 that rotate to run the belt member 31, a main body 33 that accommodates a drive mechanism D10 for rotating the two rollers 32, and a suction unit 34 that generates suction force and applies the suction force through a suction portion 37 formed on a surface of the belt member 31. Specifically, the conveyor unit 3 runs the belt member 31 while attracting a prescribed surface of the substrate 1 to the suction portion 37 of the belt member 31 by the suction force. The suction portion 37 is formed to apply the suction force therethrough and formed on the surface of the belt member 31 to travel with the belt member 31. Thus, a directional force is applied to the substrate 1 in accordance with the traveling direction of the suction portion 37.

The rollers 32 each includes a roller that is formed in a cylindrical shape and rotates around the central axis of the cylinder. As shown in FIGURE2A, the two rollers 32 are fixed to the main body 33 at positions away from each other, and the belt member 31 is stretched between the two rollers 32 and circulates around the two rollers 32. The drive mechanism D10 for rotating each of the rollers 32 is connected to the two rollers 32. The two rollers 32 rotate by operating this drive mechanism D10, and the belt member 31 accordingly runs in a state of being stretched between the two rollers 32. In the illustrated embodiment, the drive mechanism D10 includes an electronic actuator that is operatively connected to the control unit CU and is driven by the control unit CU to generate rotational force applied to the rollers 32. Of course, a gear mechanism can be provided between the actuator and the rollers 32, as needed and desired. When the belt member 31 is formed of a chain, sprockets may be used instead of the rollers 32.

The main body 33 includes a housing or case for accommodating the drive mechanism D10. The two rollers 32 are rotatably attached to this main body 33.

The suction unit 34 includes a housing provided between the two rollers 32. As shown in FIG. 2A, the suction unit 34 has an opening 35 that has about the same size as the space between the two rollers 32 in a portion of a wall portion of the housing that faces a rear surface of the belt member 31 located between the two rollers 32. A pressure reducing mechanism D12 that reduces the internal pressure of the housing is connected to the housing of the suction unit 34, and suction force is generated at the opening 35 by operating the pressure reducing mechanism D12 to create a negative pressure inside the suction unit 34 relative to the outside. In the illustrated embodiment, the pressure reducing mechanism D12 is located inside the main body 33, but the location of the pressure reducing mechanism D12 is not limited to this. For example, the pressure reducing mechanism D12 can be located inside the housing of the suction unit 34. The pressure reducing mechanism D12 includes a blower, a pump, an ejector, or the like, for example. In the illustrated embodiment, the pressure reducing mechanism D12 is operatively connected to the control unit CU and is driven by the control unit CU to generate the suction force.

In addition, as shown in FIG. 2B, a plurality of circular through-holes 36 are formed in the belt member 31. The through-holes 36 are arranged in a single row along the entire circumference of a running direction of the belt member 31 at positions where the through-holes 36 face the opening 35 while the belt member 31 runs. The suction force is generated in these through-holes 36 through the opening 35 when the through-holes 36 are located at positions facing the opening 35 in a state in which the pressure reducing mechanism D12 is being operated. In the present embodiment, each of the through-holes 36 in which the suction force is generated serves as the suction portion 37. The substrate 1 that is attracted to the suction portion 37 is fed in the traveling direction of the suction portion 37 in the suction-held state.

The conveyor units 3 having these configurations are provided so as to form pairs. As shown in FIG. 3, a pair of the conveyor units 3 includes a conveyor unit 3a that causes an uncoated portion 13 on the prescribed surface of the substrate 1 to be attracted to the suction portion 37 in the vicinity of a widthwise end la of the substrate 1, and a conveyor unit 3b that causes another uncoated portion 13 on the prescribed surface of the substrate 1 to be attracted to the suction portion 37 in the vicinity of a widthwise end lb of the substrate 1. The conveyor units 3a and 3b are arranged side-by-side in the width direction of the substrate 1.

The pair of conveyor units 3 feeds the substrate 1 in the traveling direction of the suction portion 37, while causing the prescribed surface of the substrate 1 to be attracted to the respective suction portion 37. At this time, since the pair of conveyor units 3 causes the uncoated portions 13 of the prescribed surface of the substrate 1 to be attracted to the suction portion 37 in the vicinities of the widthwise ends of the substrate 1, respectively, the pair of conveyor units 3 can feed the substrate 1 in the traveling direction of each of the suction portions 37 without coming into contact with the coating films 11, and the posture of the substrate 1 conveyed by the conveying section 2 can be maintained. In the following description, when there is no need to distinguish between the two conveyor units 3a and 3b, the conveyor unit 3a and the conveyor unit 3b are simply referred to as the conveyor units 3.

In addition, in the present embodiment, a plurality of pairs of the conveyor units 3 are provided. In the example of Fig. 1, a pair of conveyor units 3A that attracts the back surface of the substrate 1, a pair of conveyor units 3B that attracts the front surface of the substrate 1, and a pair of conveyor units 3C that attracts the back surface of the substrate 1 are provided along the transport path of the substrate 1. Since these three pairs of conveyor units 3 assist the conveying section 2 in conveying the substrate 1, the transport of the substrate 1 becomes more stable than when only one pair of the conveyor units 3 assists the transport of the substrate 1. Then, in the double-sided coating system 900, the coating mechanisms 910 and the drying mechanism 920 execute the respective processes on the substrate 1 that is conveyed by the conveying device 100 having the configuration described above. In the following description, when there is no need to distinguish between the three pairs, the pair of conveyor units 3A, the pair of conveyor units 3B, and the pair of conveyor units 3C are simply referred to as a pair of conveyor units 3.

The coating mechanisms 910 are provided for applying a coating liquid on both sides of the substrate 1 to form the coating film 11. As shown in FIG. 1, the coating mechanisms 910 include a first coating unit 911 that applies a coating liquid on the front surface of the substrate 1, a second coating unit 912 that applies a coating liquid on the back surface of the substrate 1, and a plurality of film thickness measuring units 913 that measures the thickness of the coating film formed on the substrate 1.

The first coating unit 911 includes a slot die for applying a coating liquid on the front surface of the substrate 1 to form the coating film 11 with a striped pattern. The first coating unit 911 is formed to be long in one direction (i.e., a longitudinal direction), and is provided extending in the width direction of the substrate 1. The coating roller 24 is provided at a prescribed interval from the first coating unit 911 such that the rotational axis direction of the coating roller 24 and the longitudinal direction of the first coating unit 911 are parallel to each other. In the following description, the longitudinal direction of the first coating unit 911 will be referred to as the width direction of the first coating unit 911.

As shown in FIG. 1, the first coating unit 911 includes a manifold 915 that is connected to a supply path 914 and that is long in the width direction, serving as a space for holding a coating liquid, a slit 916 that is connected to the manifold 915 and that is wide in the width direction, and a discharge port 917 that is opened having the same widthwise length as the slit 916 and that ejects the coating liquid. As a result, the coating liquid held in the manifold 915 passes through the slit 916 and is ejected onto the substrate 1 from the discharge port 917. In addition, the discharge port 917 faces the coating roller 24 across the substrate 1. That is, the discharge port 917 faces the substrate 1 on the front surface side of the substrate 1. It is thereby possible to apply the coating liquid to the substrate 1 in a state in which the distance between the discharge port 917 and the substrate 1 is maintained constant, so that it is possible to form the coating film 11 having a uniform thickness on the front surface of the substrate 1.

The first coating unit 911 is further provided with at least one shim plate for forming the coating films 11 to be formed on the substrate 1 in a striped pattern. The at least one shim plate has, for example, a substantially comb-like shape and is disposed so as to divide the slit 916 in the width direction. When the coating liquid is applied in a state in which the at least one shim plate divides the slit 916 in the width direction, the coating liquid is applied from portions where the at least one shim plate is absent and the coating liquid is not applied from the portions where the at least one shim plate is present. That is, the coating film 11 can be formed in a striped pattern.

The supply path 914 fluidly connects the manifold 915 to a tank 918 in which the coating liquid is stored. Then, the coating liquid is supplied by a pump P to the manifold 915 from the tank 918 via the supply path 914, and then passes through the slit 916 and is applied to the substrate 1 from the discharge port 917. In the illustrated embodiment, the pump P is operatively connected to the control unit CU and is driven by the control unit CU to supply the coating liquid from the tank 918 to the manifold 915.

The first coating unit 911 having these configurations can form the coating films 11 in a striped pattern on the front surface of the substrate 1.

The second coating unit 912 has a configuration similar to that of the first coating unit 911 and is disposed on the downstream side of the first coating unit 911 such that the discharge port 917 of the second coating unit 912 faces the substrate 1 on the back surface side of the substrate 1, as shown in FIG. 1. The pair of conveyor units 3A and the pair of conveyor units 3B are arranged such that the pair of conveyor units 3A and the pair of conveyor units 3B sandwich the discharge port 917 of the second coating unit 912 on the transport path of the substrate 1.

In this manner, since the pair of conveyor units 3A and the pair of conveyor units 3B can attract the substrate 1 by the suction force, it is possible to apply the coating liquid on the substrate 1 in a state in which the distance between the discharge port 917 and the substrate 1 is maintained constant. As a result, the coating films 11 having a uniform thickness can be formed in a striped pattern on the back surface of the substrate 1. The width of the coating films 11 formed on the back surface of the substrate 1 by the second coating unit 912 is preferably the same as the width of the coating films 11 formed on the front surface of the substrate 1 by the first coating unit 911.

The first coating unit 911 and the second coating unit 912 form the coating films 11 in a striped pattern on both sides of the substrate 1.

The film thickness measuring units 913 each include a film thickness sensor or detector for measuring the thickness of the coating films 11 formed on both sides of the substrate 1. The film thickness measuring units 913 each include a non-contact displacement meter or sensor, for example. In particular, the film thickness measuring units 913 includes an optical thickness sensor, a laser displacement sensor, an ultrasonic sensor, etc., for example. One of the film thickness measuring units 913 is provided between the first coating unit 911 and the second coating unit 912, and the other one of the film thickness measuring units 913 is provided between the second coating unit 912 and the drying mechanism 920 on the transport path of the substrate 1, as shown in FIG. 1. That is, the film thickness measuring units 913 individually measure the thickness of the coating films 11 formed by each of the first coating unit 911 and the second coating unit 912.

The measurement results from the film thickness measuring units 913 are reflected on the application of the coating liquid by the first coating unit 911 and the second coating unit 912. For example, the film thickness measuring units 913 are operatively connected to the control unit CU and the control units CU drives the pumps P of the first coating unit 911 and the second coating unit 912 according to the measurement results from the film thickness measuring units 913. Thus, the amounts of the coating liquid applied by the first coating unit 911 and the second coating unit 912 are adjusted according to the measurement results from the film thickness measuring units 913. It is thereby possible to form the coating films 11 having a prescribed film thickness on both sides of the substrate 1.

In addition, the pair of conveyor units 3A is disposed on the back surface side of the substrate 1 between the second coating unit 912 and the film thickness measuring unit 913 that measures the film thickness of the coating films 11 formed by the first coating unit 911 on the transport path of the substrate 1, and the film thickness measuring unit 913 measures the film thickness of the coating films 11 formed on the front surface of the substrate 1 in a state in which the substrate 1 is suctioned by the pair of conveyor units 3A. It is thereby possible to improve the accuracy of measurement by the film thickness measuring unit 913.

In addition, the pair of conveyor units 3B and the pair of conveyor units 3C are arranged such that the pair of conveyor units 3B and the pair of conveyor units 3C sandwich the film thickness measuring unit 913 that measures the film thickness of the coating films 11 formed by the second coating unit 912 on the transport path of the substrate 1. Then, the film thickness measuring unit 913 measures the film thickness of the coating films 11 formed on the back surface of the substrate 1 in a state in which the substrate 1 is attracted by the pair of conveyor units 3B and the pair of conveyor units 3C. It is thereby possible to improve the accuracy of measurement by the film thickness measuring unit 913.

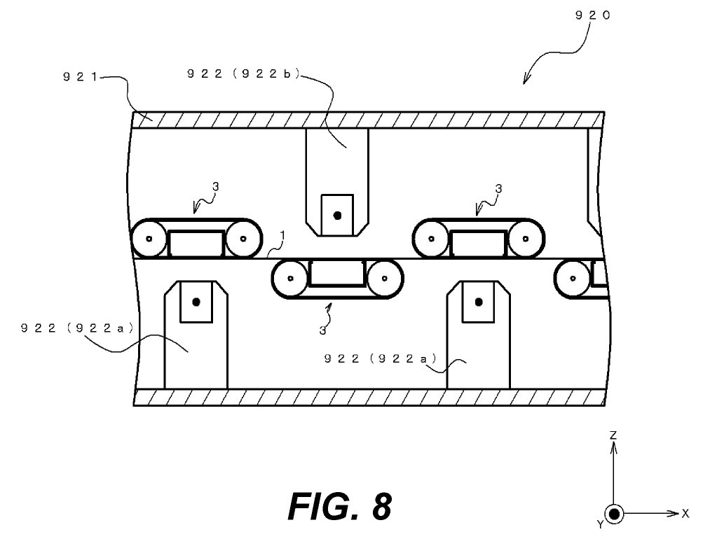

The drying mechanism 920 is a heater or dryer for heating and drying the coating films 11 formed on both sides of the substrate 1 by the coating mechanisms 910. As shown in FIG. 1, the drying mechanism 920 is provided on the downstream side of the coating mechanisms 910 on the transport path of the substrate 1, and has a housing part 921 and a plurality of heating nozzles 922 (FIG. 8).

The housing part 921 is a box or housing formed to be long in the transport direction of the substrate 1, having a space inside the box through which the substrate 1 passes, and an entrance and an exit through which the substrate 1 enters and exits this space. Then, the substrate 1 on which the coating films 11 are formed is conveyed by the conveying section 2 so as to pass through inside the housing part 921.

The heating nozzles 922 each blow hot air onto the substrate 1 to heat the coating films 11. The heating nozzles 922 are formed to be long in the width direction of the substrate 1, and each have an opening through which hot air is blown out on a portion facing the front surface or the back surface of the substrate 1. The hot air blown out from the heating nozzles 922 create high-temperature environment inside the housing part 921, and the coating films 11 are heated and dried as a result of the coating films 11 being exposed to this high-temperature environment.

As seen in FIG. 8, the heating nozzles 922 have a pair of lower nozzle 922a that is disposed below the substrate 1 and blows hot air onto the back surface of the substrate 1 in the housing part 921, and an upper nozzle 922b that is disposed above the substrate 1 and blows hot air onto the front surface of the substrate 1 in the housing part 921. The lower nozzles 922a and the upper nozzle 922b are alternately arranged in the transport direction of the substrate 1. Therefore, the substrate 1 is conveyed in a substantially straight direction in a state in which lift is applied to the substrate 1 and the substrate 1 is levitated.

The drying mechanism 920 having these configurations can dry the coating films 11 formed on both sides of the substrate 1.

In addition, there are cases in which misalignment occurs at widthwise ends of the substrate 1 during the period in which the substrate 1 that is unwound from the unwinding roller 21 passes through the conveying rollers 23 and is wound up by the winding roller 22. This misalignment is particularly likely to occur between the coating roller 24 and the conveying roller 25 on the transport path of the substrate 1 by the conveying section 2. This is because sagging occurs in the substrate 1 due to the weight of the coating films 11 formed on the substrate 1 by the coating mechanisms 910, or because the substrate 1 vibrates due to the hot air being blown by the drying mechanism 920.

Here, the conveyor units 3 are each provided with a traveling direction adjustment unit or adjustor 38 that adjusts the traveling direction of the suction portion 37 of the belt member 31. In the present embodiment, the traveling direction adjustment unit 38 includes a rotating mechanism 38a that rotates the main body 33 in the Z6 direction (around the Z-axis) and stops at any given angle, as shown in FIG. 2A.

As shown in FIG. 2A, the rotating mechanism 38a includes a support portion or base 38b that rotatably supports the main body 33, and a drive shaft 38c that is a rotational shaft for rotating the main body 33 and connects the main body 33 and the support portion 38b. The drive shaft 38c is connected to a drive mechanism D14 and is configured to rotate the main body 33 by operating the drive mechanism D14. The traveling direction of the suction portion 37 is adjusted by rotating the main body 33 using the rotating mechanism 38a, and it is possible to pull the widthwise end of the substrate 1 that is attracted to the suction portion 37 by suction force toward the adjusted traveling direction of the suction portion 37. It is thereby possible to adjust the positions of the widthwise ends of the substrate 1. In the illustrated embodiment, the drive mechanism D14 includes an electronic actuator that is operatively coupled between the support portion 38b and the drive shaft 38c, and is connected to the control unit CU and is driven by the control unit CU to generate rotational force applied to the drive shaft 38c. Thus, the traveling direction adjustment unit 38 can adjust the traveling direction of the suction portion 37 of the belt member 31 by the operation of the control unit CU.

In addition, the conveying device 100 is further provided with end position detection units 41 that detect the positions of both widthwise ends of the substrate 1, as shown in FIG. 1. The end position detection units 41 each include a sensor for detecting the positions of the widthwise ends of the substrate 1 and is disposed in the vicinity of each of the two widthwise ends of the substrate 1 so as to be in the vicinity of the pair of conveyor units 3. In particular, the end position detection units 41 each include a photoelectric sensor, a laser displacement sensor, a vision sensor or camera, etc., for example. Then, the end position detection units 41 transmit, to the control unit CU, position information of the widthwise ends of the substrate 1. In the illustrated embodiment, the end position detection units 41 are provided at two locations, as seen in FIG. 1, but the locations and/or number of the end position detection units 41 are not limited to this. The conveying device 100 can be provided with one end position detection unit 41 or three or more end position detection units 41.

The control unit CU controls the operation of the traveling direction adjustment units 38 of the conveyor units 3 on the basis of the position information of the two widthwise ends of the substrate 1 transmitted from the end position detection units 41, to adjust the traveling direction of the suction portions 37 of the conveyor units 3. That is, the traveling direction adjustment units 38 adjust the traveling direction of the suction portions 37 of the conveyor units 3, respectively, on the basis of the detection result of the positions of both widthwise ends of the substrate 1, detected by the end position detection units 41.

In addition, the control unit CU compares the positions of the two widthwise ends of the substrate 1 transmitted from the end position detection units 41 with the positions of the two widthwise ends of the substrate 1 during normal transport, to determine whether there is a misalignment in the positions of the two widthwise ends of the substrate 1. Normal transport here refers to a state in which the substrate 1 is being conveyed within a prescribed allowable error range around an ideal transport state in which the substrate 1 is conveyed without any misalignment of the substrate 1. The positions of the two widthwise ends of the substrate 1 in the ideal transport state are the positions T indicated by the dashed lines in FIGS. 4A and 4B.

When the control unit CU determines that there is a misalignment in the two widthwise ends of the substrate 1, the traveling direction adjustment units 38 adjust the traveling direction of the suction portions 37 of the conveyor units 3 so as to adjust the positions of the two widthwise ends of the substrate 1 to the normal positions. The adjustment of the traveling direction of the suction portions 37 of the conveyor units 3 by the traveling direction adjustment units 38 is carried out until the control unit CU determines that the two widthwise ends of the substrate 1 are in the normal positions on the basis of the position information of each of the widthwise ends of the substrate 1 detected by the end position detection units 41.

Specifically, the traveling direction adjustment units 38 receive feedback regarding the positions of the two widthwise ends of the substrate 1 from the control unit CU, each time the traveling direction of the suction portions 37 of the conveyor units 3 is adjusted, and, on the basis thereof, adjust the traveling direction of the suction portions 37 of the conveyor units 3. By repeating this process, it is possible to maintain the positions of the two widthwise ends of the substrate 1 in the normal positions.

A more specific explanation will be given. For example, when sagging occurs in the substrate 1 as shown in FIG. 4A and the positions of the two widthwise ends of the substrate 1 are misaligned toward the center in the vicinity of a pair of the conveyor units 3, the traveling direction adjustment units 38 of the pair of the conveyor units 3 make an adjustment such that the traveling direction of the suction portions 37 of the pair of conveyor units 3 is directed further outward in the width direction of the substrate 1 with respect to the transport direction in which the substrate 1 is conveyed by the conveying section 2, as compared to the traveling direction of the suction portions 37 prior to the adjustment. As a result, the pair of conveyor units 3 can pull the substrate 1 outward at each of the widthwise ends of the substrate 1 as compared to a state before the traveling direction of the suction portions 37 is adjusted by the traveling direction adjustment units 38, thereby reducing sagging of the substrate 1 and bringing the positions of the two widthwise ends of the substrate 1 closer to the normal positions.

In addition, when the substrate 1 is misaligned toward the end la on one side in the width direction as shown in FIG. 4B in the vicinity of a pair of the conveyor units 3, the traveling direction adjustment unit 38 of the conveyor unit 3b of the pair of the conveyor units 3 makes an adjustment such that the traveling direction of the suction portion 37 of the conveyor unit 3b, which attracts the end lb side that pairs with the end la, is directed further outward in the width direction of the substrate 1 with respect to the transport direction in which the substrate 1 is conveyed by the conveying section 2, as compared to the traveling direction of the suction portion 37 of the conveyor unit 3b prior to the adjustment. As a result, the conveyor unit 3b can pull the substrate 1 outward of the widthwise end lb of the substrate 1 as compared to a state before the suction portion 37 of the conveyor unit 3b is adjusted by the traveling direction adjustment unit 38, so that the substrate 1 is pulled toward the widthwise end lb and the positions of the two widthwise ends of the substrate 1 are brought closer to the normal positions.

The adjustment of the traveling direction of the suction portions 37 of the conveyor units 3 by the traveling direction adjustment units 38 described above is carried out until the control unit CU determines that the two widthwise ends of the substrate 1 are in the normal positions on the basis of the position information of each of the widthwise ends of the substrate 1 detected by the end position detection units 41. This allows the positions of both widthwise ends of the substrate 1 to be adjusted to and maintained at normal positions.

In addition, the traveling direction adjustment units 38 adjust the traveling direction of the suction portions 37 to be directed outward in the width direction of the substrate 1 with respect to the transport direction in which the substrate 1 is conveyed by the conveying section 2 during transport of the substrate 1 by the conveying section 2, regardless of the positions of the widthwise ends of the substrate 1. As a result, one pair of conveyor units 3 can pull the substrate 1 outward at each of the widthwise ends of the substrate 1 being transported, thereby reducing sagging of the substrate 1.

In addition, the conveyor units 3 are each provided with a speed adjustment unit 39 that adjusts the relative speed of the suction portion 37 relative to the substrate 1. In the present embodiment, the speed adjustment unit 39 is formed by the control unit CU and the drive mechanism D10 that rotates the two rollers 32 of each of the conveyor units 3. The control unit CU controls the operation of the drive mechanism D10 to control the rotation speed of the two rollers 32, thereby adjusting the running speed of the belt member 31, that is, the traveling speed of the suction portion 37 of each of the conveyor units 3.

The speed adjustment unit 39 adjusts the relative speed of each of the suction portions 37 relative to the substrate 1 in accordance with the traveling direction of each of the suction portions 37 adjusted by the corresponding one of the traveling direction adjustment units 38. Specifically, as shown in FIG. 2B, the speed adjustment unit 39 adjusts a traveling speed Vxy of the suction portion 37 each time the traveling direction of the suction portion 37 is adjusted such that a transport direction component Vx of the traveling speed Vxy of the suction portion 37 along the transport direction in which the substrate 1 is conveyed by the conveying section 2 becomes equal to the transport speed V of the substrate 1 by the conveying section 2.

As a result, it becomes possible to adjust the relative speed of each of the suction portions 37 of the conveyor units 3 with respect to the substrate 1 in accordance with the traveling direction of each of the suction portions 37 adjusted by the traveling direction adjustment units 38. Therefore, the substrate 1 being conveyed by the conveying section 2 does not become clogged on the suction portions 37 of the belt members 31 of the conveyor units 3, and the conveyor units 3 can adjust the positions of the widthwise ends of the substrate 1 without impeding the transport of the substrate 1 by the conveying section 2.

In addition, the conveying device 100 further comprises first moving mechanisms D16 that moves the conveyor units 3 back and forth, respectively, in the transport direction in which the substrate 1 is conveyed by the conveying section 2. In the present embodiment, the first moving mechanisms D16 each include a rail D16a extending in the transport direction of the substrate 1 and a slider part or slider D16b that moves on the rail D16a, and the support portion 38b is connected to the slider part D16b. A drive mechanism D18 that moves and stops the slider part D16b is connected to the slider part D16b, and the drive mechanism D18 moves the slider part D16b on the rail D16a, thereby moving corresponding one of the conveyor units 3 back and forth in the transport direction in which the substrate 1 is conveyed. Each of the conveyor units 3 can be moved back and forth in the transport direction in which the substrate 1 is conveyed, whereby it is possible to set, over a wide range, the direction in which each of the conveyor units 3 pulls a widthwise end of the substrate 1. In the illustrated embodiment, the drive mechanism D18 includes an electronic actuator that is operatively coupled between the rail D16aand the slider part D16b, and is connected to the control unit CU and is driven by the control unit CU to relatively move the slider part D16b along the rail D16a. Specifically, the drive mechanism D18 can be a ball screw drive, in which a screw shaft or ball screw is rotated by the actuator to cause the slider part D16b to move along the rail D16a, a rack and pinion drive, in which a pinion gear that engages with a linear rack connected to the slider part D16b is rotated by the actuator, a timing belt drive, in which a timing belt to which the slider part D16b is attached is driven by the actuator, or a linear motor drive, in which the actuator includes a linear motor to move the slider part D16b along the rail D16a using electromagnetic force, etc.

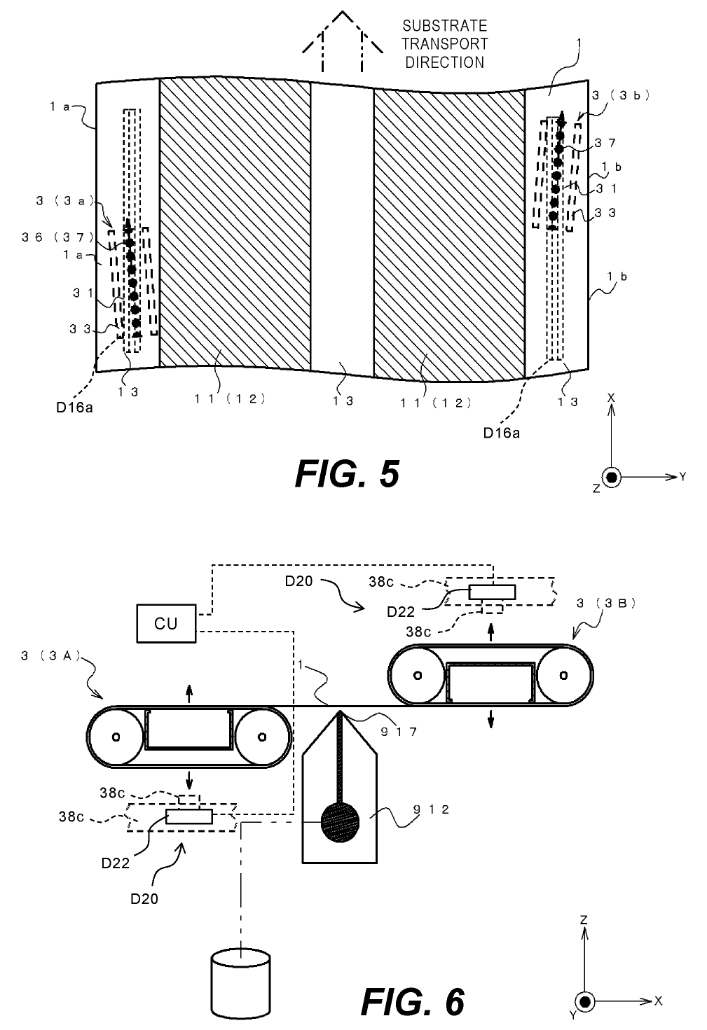

In addition, as shown in FIG. 5, the first moving mechanisms D16 may move each of the pair of conveyor units 3 such that the pair of conveyor units 3 are arranged offset from each other in the front-rear direction of the transport direction of the substrate 1. In this case, it becomes easier to pull the substrate 1 in the traveling direction of the suction portion 37 of the conveyor unit 3 on one side, as compared to when the pair of conveyor units 3 are arranged side- by-side in the width direction of the substrate 1. It thereby becomes easier to adjust the positions of the widthwise ends of the substrate 1.

In addition, the conveyor units 3 adjust the suction force that is applied to the suction portions 37 by means of the pressure reducing mechanisms D12, respectively. In the present embodiment, when adjusting the positions of the widthwise ends of the substrate 1, the adjustment is made so that there is a difference in the suction force that is applied to the suction portions 37 of the pair of the conveyor units 3, respectively.

For example, when an adjustment is made so that the suction force applied to the suction portion 37 of the conveyor unit 3a of the pair of the conveyor units 3 becomes large and the suction force applied to the suction portion 37 of the conveyor unit 3b of the pair of the conveyor units 3 becomes small, the substrate 1 located on the suction portion 37 of the conveyor unit 3b slides or slips on the suction portion 37 of the conveyor unit 3b toward the traveling direction of the suction portion 37 of the conveyor unit 3a by a force of the conveyor unit 3a that pulls the substrate 1 outward of the widthwise end la of the substrate 1 As a result, it becomes easier to pull the substrate 1 in the traveling direction of the suction portion 37 of the conveyor unit 3 on one side (e.g., the conveyor unit 3a in the case described above). It thereby becomes easier to adjust the positions of the widthwise ends of the substrate 1.

In addition, the conveying device 100 further comprises second moving mechanisms D20 that move the conveyor units 3 in directions moving closer to (toward) or away from the prescribed surface of the substrate 1, respectively. In the present embodiment, the second moving mechanisms D20 are each formed by the support portion 38b and the drive shaft 38c of corresponding one of the conveyor units 3. The drive shaft 38c is retracted into the support portion 38b or extended out of the support portion 38b in order to raise and lower the conveyor units 3. The operation of the drive shaft 38c is carried out by a drive mechanism D22. It is thereby possible to adjust the position of the substrate 1 in a direction perpendicular to the prescribed surface of the substrate 1. In the illustrated embodiment, the drive mechanism D22 includes an electronic actuator that is operatively coupled between the support portion 38b and the drive shaft 38c, and is connected to the control unit CU and is driven by the control unit CU to relatively and axially move the drive shaft 38c relative to the support portion 38b. Specifically, the drive mechanism D22 can be a cam and follower mechanism that axially moves the drive shaft 38c by the operation of the actuator, a ball screw drive that axially moves the drive shaft 38c by the operation of the actuator, etc. In either case, the drive shaft 38ccan have a serrated portion formed along its outer circumferential surface to allow torque transmission from the drive mechanism D14 while permitting axial movement by the drive mechanism D22.

In addition, as shown in FIG. 6, the pair of the conveyor units 3A and/or the pair of the conveyor units 3B can be moved by the second moving mechanisms D20 in a direction moving closer to or away from the prescribed surface of the substrate 1, thereby adjusting the distance between the substrate 1 and the discharge port 917 of the second coating unit 912.

In this manner, according to the conveying device 100 described above, the traveling direction adjustment units 38 can adjust the traveling direction of the suction portions 37 of the belt members 31 of the conveyor units 3 that attract the prescribed surface of the substrate 1 onto the suction portions 37 of the belt members 31 by the suction force in the vicinities of both widthwise ends of the substrate 1, respectively. Therefore, it is possible to pull the ends of the substrate 1 toward the adjusted traveling direction of the suction portions 37 of the belt members 31, respectively. It is thereby possible to adjust the positions of the widthwise ends of the substrate 1 being conveyed.

In addition, since the double-sided coating system 900 according to the present embodiment comprises the conveying device 100 of the embodiment described above, it is possible to carry out the application of the coating liquid by the coating mechanisms 910 and the drying of the coating films 11 by the drying mechanism 920 with respect to the substrate 1 that is being stably conveyed with no misalignment in the positions of the two widthwise ends of the substrate 1. Accordingly, the double-sided coating system 900 can form the coating films 11 having a uniform thickness on both sides of the substrate 1.

An embodiment of the present invention is described in detail above with reference to the drawings, but the configurations in the embodiment and combinations thereof are merely examples, and additions, omissions, substitutions, and other modifications can be made without departing from the scope of the present invention.

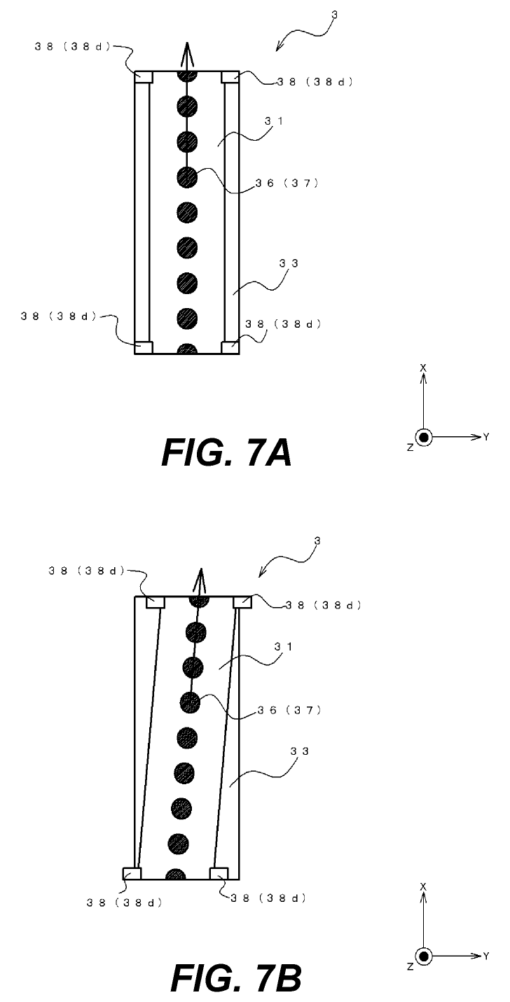

For example, in the embodiment described above, an example is described in which the traveling direction adjustment units 38 include the rotating mechanisms 38a, but the traveling direction adjustment units 38 may be formed by a plurality of guide portions 38d. A specific explanation will be given. The guide portions 38d are members for defining or guiding the running path of the belt members 31. The traveling direction adjustment units 38 each includes two pairs of the guide portions 38d that are provided so as to grip both ends of the belt member 31 of corresponding one of the conveyor units 3 in a direction perpendicular to the traveling direction of the suction portion 37 near each of the two rollers 32, as shown in FIG. 7A. Then, as shown in FIG. 7B, the positions of each of these two pairs of the guide portions 38d are shifted in mutually different directions perpendicular to the traveling direction of the suction portion 37, thereby tilting the belt member 31 and adjusting the traveling direction of the suction portion 37.

In addition, in the embodiment described above, an example is described in which the end position detection units 41 each detect the positions of the widthwise ends of the substrate 1, and the traveling direction adjustment units 38 adjust the traveling direction of the suction portions 37 of the conveyor units 3 on the basis of the detection result, but the invention is not limited thereto. For example, as seen in FIG. 1, sag amount detection units 141 that detects the position of the widthwise central portion of the substrate 1 can be provided, instead of the end position detection units 41, and the traveling direction of the suction portions 37 of the conveyor units 3 can be adjusted on the basis of the detection result from the sag amount detection units 141.

The sag amount detection units 141 each include a sensor that detects the position of the widthwise central portion of the substrate 1 in the height direction (i.e., a height position of the widthwise central portion of the substrate 1). In particular, the sag amount detection units 141 each include a photoelectric sensor, a laser displacement sensor, etc., for example. The sag amount detection units 141 transmit the detected position information to the control unit CU. The control unit CU calculates the amount of sag of the substrate 1 from the position information of the widthwise central portion of the substrate 1 in the height direction transmitted from the sag amount detection unit 141. Then, the control unit CU controls the operation of the traveling direction adjustment units 38 on the basis of the calculated sag amount of the substrate 1, and adjusts the traveling direction of the suction portions 37 of the conveyor units 3. As a result, it becomes easier to reduce the sagging of the substrate 1.

Additionally, the arrangement of the conveyor units 3 is not limited to that shown in FIG. 1. The conveyor units 3 can be positioned at positions where it is possible to attract at least one of the front surface and the back surface of the substrate 1 by suction force. For example, each of the conveyor units 3 can be disposed so as to attract only one of the surfaces of the substrate 1.

In addition, the conveyor units 3 can be disposed inside the housing part 921. In this case, as shown in FIG. 8, the conveyor units 3 can be provided so as to sandwich the substrate 1 together with the respective heating nozzles 922 inside the housing part 921. As a result, since the prescribed surface of the substrate 1 can be attracted by the conveyor units 3 at positions opposing the heating nozzles 922, respectively, it is possible to suppress vibration of the substrate 1 caused by the hot air that is blown out from the heating nozzles 922.

In addition, in the embodiment described above, an example is described in which the substrate 1 is attracted to the suction portions 37 of the conveyor units 3 by applying suction force to the suction portions 37, but the present invention is not limited thereto. For example, static electricity can be generated on the surfaces of the belt members 31 of the conveyor units 3 so that the portions where the static electricity is generated serves as the suction portions 37, thereby causing the suction portions 37 to attract the substrate 1 by the static electricity.

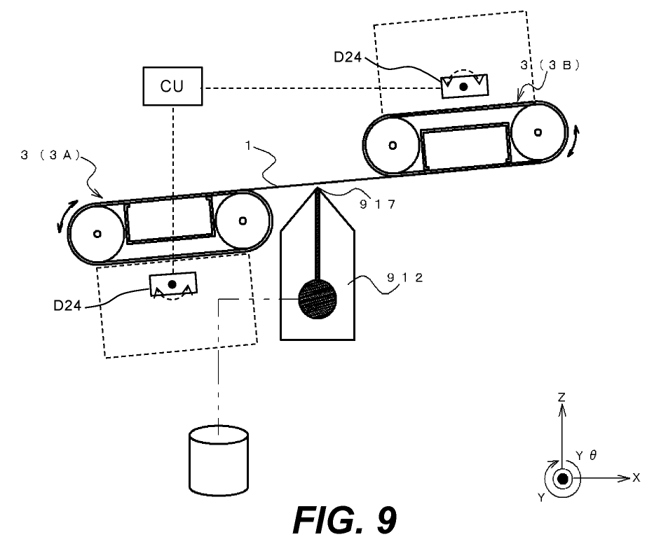

In addition, in the embodiment described above, an example is described in which the adjustment of the distance between the second coating unit 912 and the substrate 1 is carried out by moving the pair of the conveyor units 3A and/or the pair of the conveyor units 3B in a direction moving closer to or away from the prescribed surface of the substrate 1, but the adjustment can be carried out by other means. For example, as shown in Figure 9, rotating mechanisms D24 that rotate the conveyor units 3 in the Yθ direction and stop at any given angle, respectively, can be provided. The rotating mechanisms D24 can adjust the angle of the pair of the conveyor units 3A and/or the pair of the conveyor units 3B in the Yθ direction of the conveyor units 3, respectively, thereby adjusting the distance between the second coating unit 912 and the substrate 1. In the illustrated embodiment, the rotating mechanisms D24 each include an electronic actuator that is connected to the control unit CU and is driven by the control unit CU to adjust the angle of the conveyor units 3.

What is claimed is:

1. A conveying device comprising:
a conveying section configured to convey a strip-shaped substrate in a transport direction;
and at least a pair of conveyor units configured to assist transport of the substrate by the conveying section, the conveyor units each including a belt member with a suction portion to which a prescribed surface of the substrate in a vicinity of corresponding one of widthwise ends of the substrate is configured to be attracted by suction force, the belt member being configured to apply a directional force to the substrate in accordance with a traveling direction of the suction portion, anda traveling direction adjustment unit that is configured to adjust the traveling direction of the suction portion.

2. The conveying device according to claim 1, further comprising an end position detection unit configured to detect positions of the widthwise ends of the substrate,
the traveling direction adjustment unit being configured to adjust the traveling direction of the suction portion on the basis of detection result from the end position detection unit.

3. The conveying device according to claim 1, wherein the traveling direction adjustment unit is configured to adjust the traveling direction of the suction portion to be directed further outward in a width direction of the substrate with respect to the transport direction.

4. The conveying device according to claim 1, wherein the conveyor units each further include a speed adjustment unit that is configured to adjust relative speed of the suction portion relative to the substrate in accordance with an adjustment of the traveling direction of the suction portion by the traveling direction adjustment unit.

5. The conveying device according to claim 1, further comprising a first moving mechanism that is configured to move the conveyor units back and forth along the transport direction.

6. The conveying device according to claim 1, further comprising a second moving mechanism that is configured to move the conveyor units toward or away from the prescribed surface of the substrate.

7. The conveying device according to claim 1, further comprising a sag amount detection unit that is configured to detect a height position of a widthwise central portion of the substrate,
the traveling direction adjustment unit being configured to adjust the traveling direction of the suction portion on the basis of detection result from the sag amount detection unit.

8. The conveying device according to claim 2, wherein the traveling direction adjustment unit is configured to adjust the traveling direction of the suction portion to be directed further outward in a width direction of the substrate with respect to the transport direction.

9. The conveying device according to claim 2, wherein the conveyor units each further include a speed adjustment unit that is configured to adjust relative speed of the suction portion relative to the substrate in accordance with an adjustment of the traveling direction of the suction portion by the traveling direction adjustment unit.

10. The conveying device according to claim 2, further comprising a first moving mechanism that is configured to move the conveyor units back and forth along the transport direction.

11. The conveying device according to claim 2, further comprising a second moving mechanism that is configured to move the conveyor units toward or
away from the prescribed surface of the substrate.

12. The conveying device according to claim 2, further comprising a sag amount detection unit that is configured to detect a height position of a widthwise central portion of the substrate,
the traveling direction adjustment unit being configured to adjust the traveling direction of the suction portion on the basis of detection result from the sag amount detection unit.
